(19) United States
(12) Patent Application Publication
(10) Pub. No.: US 2023/0050568 A1
(43) Pub. Date: Feb. 16, 2023

(54) USER INTERFACE FOR SURFACING ACTION ITEMS

(71) Applicant: HEWLETT PACKARD ENTERPRISE DEVELOPMENT LP, Houston, TX (US)

(72) Inventors: THOMAS TOSI, Nashua, NH (US); Heidi Tosi, Nashua, NH (US); Janice Mary Foley, Roseville, CA (US)

(21) Appl. No.: 17/400,949

(22) Filed: Aug. 12, 2021

(51) Int. Cl. G06F 3/0482; G06F 3/0483

(52) U.S. Cl. CPC G06F 3/0482; G06F 3/0483

(57) ABSTRACT

Systems and methods are provided for providing a user interface for surfacing action items. The user interface can surface action items to be performed by a user. The action items can be provided in a circle scheme or a table scheme. The user can select an action item, and in response, the user interface can provide additional information associated with the action item. The user interface can also provide various functionalities associated with performing a task corresponding to the action item.

### BACKGROUND

As computer technology becomes increasingly involved in various industries, so too do the technological challenges of developing user interfaces that allow users to efficiently and effectively utilize computer technology in the unique practices of these various industries. As an example of a user interface, a graphical user interface (GUI) allows users to interact with a computing device using visual elements presented on a display. The GUI can facilitate various functions, such as accessing information on the computing device, within a local network, or over the Internet.

### BRIEF DESCRIPTION OF THE DRAWINGS

The present disclosure, in accordance with one or more various aspects, is described in detail with reference to the following figures. The figures are provided for purposes of illustration only and merely depict typical or example aspects.

FIG. 1 illustrates an example task flow chart that may be implemented for an organization, such as a business, educational institution, governmental entity, healthcare facility or other organization.

FIG. 2A illustrates an example computing component for surfacing action items.

FIGS. 2B-2C illustrate example methods for surfacing action items.

FIGS. 3A-3D illustrate example user interfaces associated with surfacing action items.

FIGS. 4A-4C illustrate example user interfaces associated with interacting with an action item.

FIG. 5 is an example computing component that may be used to implement various features of aspects described in the present disclosure.

The figures are not exhaustive and do not limit the present disclosure to the precise form disclosed.

### DETAILED DESCRIPTION

In various industries, computer technology is used to implement different processes or task flows. Various technological challenges arise in the use of computer technology to implement these task flows. These technological challenges include the development of user interfaces that efficiently provide for presentation and navigation of the task flows. A task flow can include a sequence of action items that may be performed by different users. The action items may be dependent on performance of preceding action items in the task flow. A user may be responsible for an action item in the task flow and, when the user performs the action item, another user may be responsible for the next action item in the task flow. If the user fails to timely perform the action item, the other user may not be able to perform the next action item in the task flow. Because different users may be responsible for different action items in a task flow, it can be unclear which action item in the task flow needs to be performed. If it is unclear which action item in the task flow needs to be performed, then performance of the action items in the task flow may be delayed or remain incomplete. These inefficiencies are exacerbated where users are involved in multiple task flows. A user involved in multiple task flows may spend an inordinate amount of time searching and browsing through the task flows in which the user is involved in order to identify action items for which the user is responsible. Further, searching and browsing through the task flows may result in the user missing an action item for which the user is responsible. Thus, the use of computer technology to implement different task flows poses technological challenges in efficiently providing for presentation and navigation of the task flows.

Accordingly, disclosed are methods and systems for providing (e.g., presenting, causing display of) a user interface for surfacing action items. As described above, a work flow can include a sequence of action items to be performed by different users. The user interface can be provided to one of the users. The user interface can surface the action items to be performed by the user to whom the user interface is provided. The user interface can provide action items as, for example, circles (e.g., bubbles). Each circle can serve as a link to additional information and additional interactions associated with the corresponding action item. Each circle can be colored or include an icon to represent a status (e.g., critical, awaiting action, in progress) associated with the corresponding action item. The user interface can group the action items based on different filters (e.g., geographical location, severity, service level, status, account name). Each circle representing an action item can be grouped within a larger circle based on a filter. By using this circle scheme, the user interface identifies action items for a user that merit attention from the user. Using this circle scheme also allows the user interface to provide useful contextual information without relying on text. In some cases, a user may prefer contextual information provided by text instead of visual cues. The user interface can, in some cases, use a table scheme that provides action items as entries in a table. In the table scheme, the entries can serve as links to additional information and additional interactions associated with the action items. Each entry can include text to indicate a status associated with the corresponding action item. The entries can be ordered in the table based on different filters. The user interface can provide an option to switch between the circle scheme and the table scheme, providing the user with flexibility in how the action items are provided. Surfacing action items in a user interface allows for improvements in efficiency and effectiveness in presentation and navigation of task flows, as described herein.

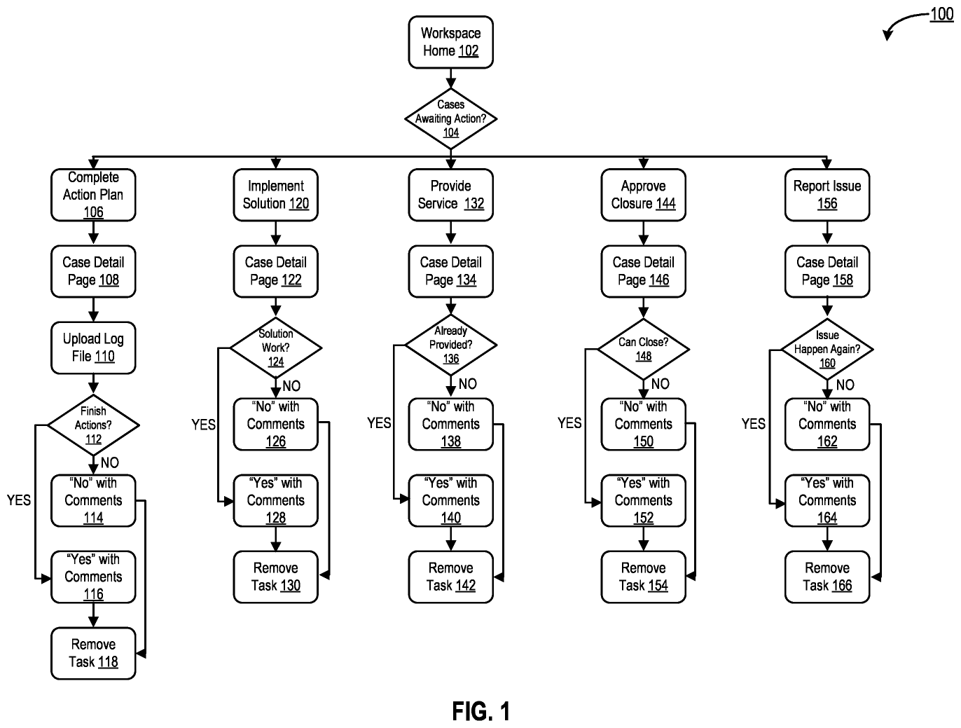

Before describing aspects of the disclosed systems and methods in detail, it is useful to describe example task flows which may be implemented in various applications of the disclosed systems and methods. FIG. 1 illustrates an example task flow chart 100 that may be implemented for an organization, such as a business, educational institution, governmental entity, healthcare facility or other organization. For example, the example task flow chart 100 may be implemented by a user managing service requests on behalf of a service provider organization. The user managing service requests may follow different sequences of action items depending on the service request. As illustrated in FIG. 1, the example task flow chart includes several task flows, or sequences of action items, that branch and loop based on performance of particular action items. In some cases, progression in a task flow depends on performance of a particular action item, and the task flow cannot progress unless the particular action item is performed. Thus, surfacing these particular action items is important to the efficient and effective progression of these task flows.

An example implementation of the example task flow chart can involve an example case where a user makes a service request (e.g., a request for support services) to a service manager of a service provider organization. Prior to the example task flow chart 100, a user may submit a service request, and the service manager may attempt to complete the service request. During the attempt to complete the service request, the service manager may encounter an impasse and require action from the user. In response, the service manager may pause the service request and create an action item for the user. In this example implementation, the service manager may request a task path represented in the example task flow chart 100 for the user to complete, and the appropriate action item can be presented in a user interface for the user. Completion of the requested task path allows the service manager to complete the service request. As illustrated in FIG. 1, the example task flow chart 100 begins with a workspace home action item 102. The workspace home action item 102 is a starting point action item for the task flow chart 100. As a starting point action item, the workspace home action item 102 may correspond with an initial task to be performed before accessing the various task flows and action items to be performed by the user. For example, the workspace home action item 102 can correspond with a log in or clock in task. In some cases, the workspace home action item 102 may not correspond with a particular task. For example, the workspace home action item 102 can be provided as a starting page for the user to access action items associated with various service requests. Following the workspace home action item 102 in the example task flow chart 100, a cases awaiting action determination 104 is performed. The cases awaiting action determination 104 checks if the user has cases awaiting action items to be performed. Following the cases awaiting action determination 104, the example task flow chart 100 proceeds to the various task flows and action items to be performed.

The example task flow chart 100 illustrates five example task flows. For the example case where a user makes a service request to a service manager of a service provider organization, resolving the service request can involve completion of one or more of the example task flows. In the example task flow chart 100, a first task flow involves a complete action plan action item 106. The complete action plan action item 106 can correspond with a task to complete an action plan for resolving the service request. The action plan can involve various actions for resolving the service request. Following the complete action plan action item 106, the first task flow involves a case detail page action item 108. To perform the case detail page action item 108, the user can input information describing the action plan in a case detail page. The case detail page action item 108 is performed when the user completes inputting the information on the case detail page. Following performance of the case detail page action item 108, the first task flow involves an upload log file action item 110. To perform the upload log file action item 110, the user can upload a log file associated with the action plan. The upload log file action item 110 is performed when the user uploads the log file. Following performance of the upload log file action item 110, a finish actions determination 112 is performed. The finish actions determination 112 checks if the various actions for resolving the service request were finished. In a case where the various actions were finished, then following a determination that the various actions for resolving the service requests were finished, the first task flow involves a yes with comments action item 116. To perform the yes with comments action item 116, the user can provide comments explaining that the various actions for resolving the service request were finished. The yes with comments action item 116 is performed when the user provides the comments and confirms that the various actions were finished. Following the performance of the yes with comments action item 116, the first task flow involves a remove task action item 118. The remove task action item 118 is associated with conclusion of the task to complete the action plan for resolving the service request. Performance of the remove task action item 118 can involve a confirmation that the task to complete the action plan is concluded and can be removed. In a case where the various actions were not finished, then following a determination that the various actions for resolving the service requests were not finished, the first task flow involves a no with comments action item 114. To perform the no with comments action item 114, the user can provide comments explaining that the various actions for resolving the service request were not or could not be finished. The no with comments action item 114 is performed when the user provides the comments and confirms that the various actions were not finished. Following the performance of the no with comments action item 114, the first task flow can involve the remove task action item 118. In the case where the various actions were not finished, then performance of the remove task action item 118 can involve a determination that the task to complete the action plan be removed even though the various actions were not finished. For example, it may be determined that the action plan cannot be completed. Upon completion of the task flow, the action item for the user may be automatically removed, and the service manager can resume the service request.

In the example task flow chart 100, a second task flow involves an implement solution action item 120. The user may see that the service manager has created a solution for the user to implement. The implement solution action item 120 can correspond with a task to implement a solution for resolving the service request. Following the implement solution action item 120, the second task flow involves a case detail page action item 122. To perform the case detail page action item 122, the user can access details on the case detail page and be refamiliarized with the service request. The user may implement the solution created by the service manager and determine whether the solution worked or not. The case detail page action item 122 is performed when the user accesses the case detail page. Following performance of the case detail page action item 122, a solution work determination 124 is performed. The solution work determination 124 checks if the solution for resolving the service request worked (e.g., resolved the issue associated with the service request). In a case where the solution worked, then following a determination that the solution worked, the second task flow involves a yes with comments action item 128. To perform the yes with comments action item 128, the user can provide comments explaining that the solution for resolving the service request worked. The yes with comments action item 128 is performed when the user provides the comments and confirms that the solution worked. Following the performance of the yes with comments action item 126, the second task flow involves a remove task action item 130. The remove task action item 130 is associated with conclusion of the task to implement the solution for resolving the service request. Performance of the remove task action item 130 can involve a confirmation that the task to implement the solution is concluded and can be removed. In a case where the solution did not work, then following a determination that the solution did not work (e.g., did not resolve the issue associated with the service request), the second task flow involves a no with comments action item 126. To perform the no with comments action item 126, the user can provide comments explaining that the solution did not work or could not be implemented. The no with comments action item 126 is performed when the user provides the comments and confirms that the solution did not work. The comments provided by the user may be captured in the case detail page and be visible to the user and the service manager (or others with access to the case detail page. Following the performance of the no with comments action item 126, the second task flow can involve the remove task action item 130. In the case where the solution did not work, then performance of the remove task action item 130 can involve a determination that the task to implement the solution can be removed even though it did not work. For example, it may be determined that the solution was implemented but did not work or that the solution could not be implemented. Upon completion of the task flow, the action item for the user may be automatically removed, and the service manager can resume the service request.

In the example task flow chart 100, a third task flow involves a provide service action item 132. The provide service action item 132 can correspond with a task to provide a service for resolving the service request. The user may see that the service manager has provided information about an on-site visit to provide certain services. Following the provide service action item 132, the third task flow involves a case detail page action item 134. To perform the case detail page action item 134, the user can access details related to the on-site visit. The user can confirm the on-site visit. The case detail page action item 134 is performed when the user accesses the case detail page. Following performance of the case detail page action item 134, an already provided determination 134 is performed. The already provided determination 134 checks if the service for resolving the service request has already been provided. In a case where the service was already provided, then following a determination that the service was provided, the third task flow involves a yes with comments action item 140. To perform the yes with comments action item 140, the user can provide comments explaining that the service was provided and whether the service helped to resolve the service request. The yes with comments action item 140 is performed when the user provides the comments and confirms that the service was provided. Following the performance of the yes with comments action item 140, the third task flow involves a remove task action item 142. The remove task action item 142 is associated with conclusion of the task to provide a service for resolving the service request. Performance of the remove task action item 142 can involve a confirmation that the task to provide the service is concluded and can be removed. In a case where the service was not already provided, then following a determination that the service was not provided, the third task flow involves a no with comments action item 138. To perform the no with comments action item 138, the user can provide comments explaining that the service was not provided and whether the service can be provided. The no with comments action item 138 is performed when the user provides the comments and confirms that the service was not provided. Following the performance of the no with comments action item 138, the third task flow can involve the remove task action item 142. In the case where the service was not provided, then performance of the remove task action item 142 can involve a determination that the task to provide the service can be removed even though the service was not provided. For example, it may be determined that the service cannot be provided. Upon completion of the task flow, the action item for the user may be automatically removed, and the service manager can resume the service request.

In the example task flow chart 100, a fourth task flow involves an approve closure action item 144. The approve closure action item 144 can correspond with a task to confirm the service request was resolved. The user may see that the service manager requested the service request be closed and provided the user an opportunity to confirm or approve the closure of the service request. Following the approve closure action item 144, the fourth task flow involves a case detail page action item 146. To perform the case detail page action item 146, the user can access details on the case detail page and be refamiliarized with the service request. The user can determine whether the service request can be closed. The case detail page action item 146 is performed when the user accesses inputting the information on the case detail page. Following performance of the case detail page action item 146, a can close determination 148 is performed. The can close determination 148 checks if the service request can be resolved (e.g., the issue associated with the service request was fixed). In a case where the service request can be resolved, then following a determination that the service request can be resolved, the fourth task flow involves a yes with comments action item 152. To perform the yes with comments action item 152, the user can provide comments explaining that the service request can be resolved. The yes with comments action item 152 is performed when the user provides the comments and confirms that the service request can be resolved. Following the performance of the yes with comments action item 152, the fourth task flow involves a remove task action item 154. The remove task action item 154 is associated with conclusion of the task to confirm the service request was resolved. Performance of the remove task action item 130 can involve a confirmation that the task to confirm the service request was resolved is concluded and can be removed. In a case where the service request cannot be resolved, then following a determination that the service request cannot be resolved (e.g., the issue associated with the service request was not fixed), the second task flow involves a no with comments action item 150. To perform the no with comments action item 150, the user can provide comments explaining that the service request cannot be resolved. The no with comments action item 150 is performed when the user provides the comments and confirms that the service request cannot be resolved. Following the performance of the no with comments action item 150, the fourth task flow can involve the remove task action item 154. In the case where the service request cannot be resolved, then performance of the remove task action item 154 can involve a determination that the task to confirm the service request was resolved can be removed even though it cannot be resolved. For example, it may be determined that additional task flows will be associated with the service request. Upon completion of the task flow, the action item for the user may be automatically removed, and the service manager can resume the service request.

In the example task flow chart 100, a fifth task flow involves a report issue action item 120. The report issue action item 156 can correspond with a task to report an issue associated with the service request. The user may see that the service manager has requested a report of whether the issue associated with the service request has recurred or is an intermittent issue. Following the report issue action 156, the fifth task flow involves a case detail page action item 158. To perform the case detail page action item 158, the user can access details on the case detail page and be refamiliarized with the service request. The user may determine whether the issues has recurred or is an intermittent issue. The case detail page action item 158 is performed when the user accesses the case detail page. Following performance of the case detail page action item 158, an issue happen again determination 160 is performed. The issue happen again determination 160 checks if the issue associated with the service request has happened before (e.g., the issue has recurred). In a case where the issue has happened before, then following a determination that the issue has happened before, the fifth task flow involves a yes with comments action item 164. To perform the yes with comments action item 164, the user can provide comments explaining that the issue has recurred. The yes with comments action item 164 is performed when the user provides the comments and confirms that the issue is ongoing. Following the performance of the yes with comments action item 164, the fifth task flow involves a remove task action item 166. The remove task action item 166 is associated with conclusion of the task to implement the solution for resolving the service request. Performance of the remove task action item 130 can involve a confirmation that the task to report an issue associated with the service request is concluded and can be removed. For example it may be determined that the issue will be escalated. In a case where the issue has not happened before, then following a determination that the issue has not happened before (e.g., the issue is new), the fifth task flow involves a no with comments action item 162. To perform the no with comments action item 162, the user can provide comments explaining that the issue is new. The no with comments action item 162 is performed when the user provides the comments and confirms that the issue is new. Following the performance of the no with comments action item 162, the fifth task flow can involve the remove task action item 166. In the case where the issue has not happened before, then performance of the remove task action item 162 can involve a determination that the task to report an issue associated with the service request can be removed. For example, it may be determined that the issue does not need to be escalated because it is new. Upon completion of the task flow, the action item for the user may be automatically removed, and the service manager can resume the service request.

As illustrated in FIG. 1, a case may involve multiple options available to a service manager. These task flows may involve different action items performed by a user. Thus, a service request may be delayed or fail to progress due to a number of different action items that are awaiting performance by a user. This can lead to an inefficient resolution of a service request as the user may be unaware that the service request is being delayed due to an action item to be performed by the user. Although FIG. 1 illustrates an example task flow chart with five task flows, in various implementations, a case can involve a larger number of task flows. The task flows can involve a larger number of action items. While the example described in FIG. 1 involves an example case where a customer makes a service request to a service manager, the task flows and action items described may vary for different situations. Many variations are possible. As illustrated in the example of FIG. 1, a user may spend an inordinate amount of time searching and browsing through task flows to identify action items to perform. Further, performance of action items in a task flow may involve other users (e.g., different users within a customer organization, different parties other than the customer or the service manager such as independent vendors or the like, etc.), and delays in searching and browsing through task flows to identify action items to perform may cause further delays to the progress of the task flows. Surfacing action items for a user to perform and presenting the surfaced action items together in a user interface, as described herein, provides improvements that address these challenges.

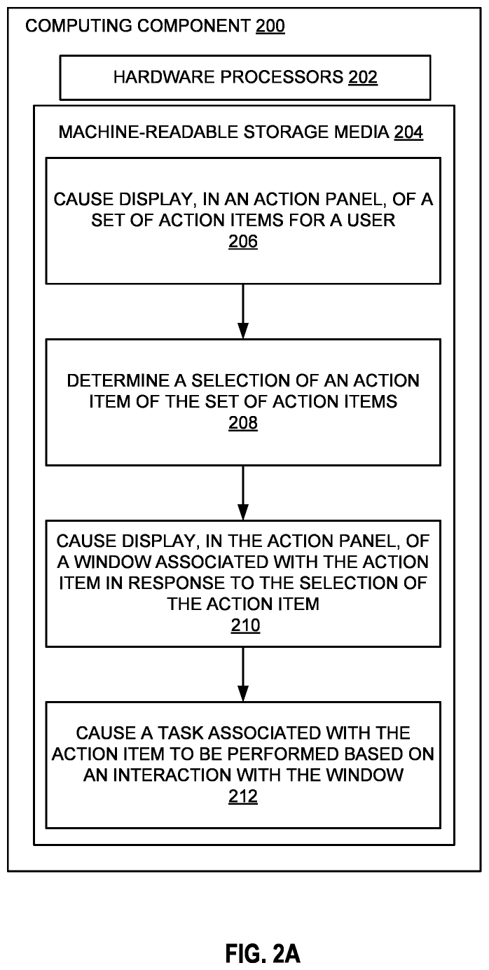

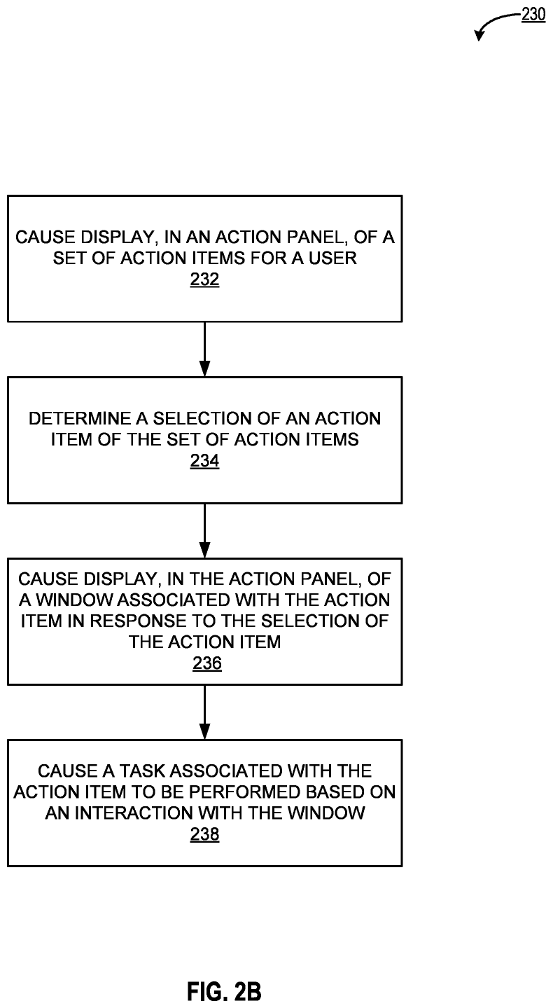

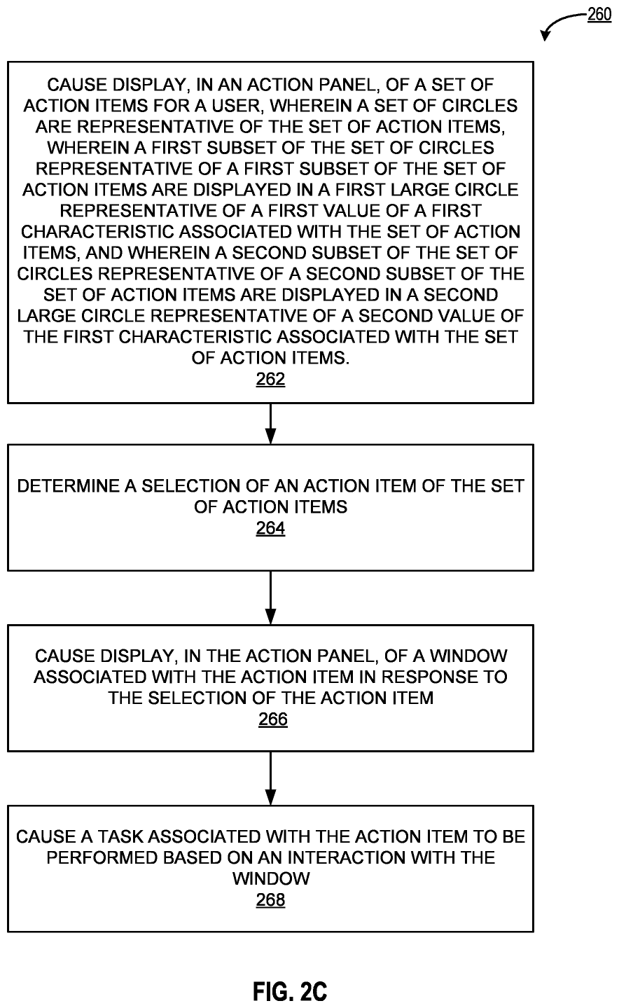

FIG. 2 is a block diagram of an example computing component or device 200 for providing a user interface for surfacing action items in accordance with various aspects. Computing component 200 may be, for example, a server computer, a client device, a controller, or any other similar computing component capable of processing data. In some cases, a user interface for surfacing action items can be provided, for example, as a website, a web page, or an application interface. In some cases, a user interface for surfacing action items can be provided as an application. In some implementations, the computing component 200 may be operated by an infrastructure vendor or service provider, and the user interface may be presented to a customer of the infrastructure vendor or service provider on, for example, a client computer of the customer. Many variations are possible. In the example implementation of FIG. 2, the computing component 200 includes a hardware processor 202 and machine-readable storage medium 204.

Hardware processor 202 may be one or more central processing units (CPUs), semiconductor-based microprocessors, and/or other hardware devices suitable for retrieval and execution of instructions stored in machine-readable storage medium 204. Hardware processor 202 may fetch, decode, and execute instructions, such as instructions 206-212, to control processes or operations for providing a user interface for surfacing action items. As an alternative or in addition to retrieving and executing instructions, hardware processor 202 may include one or more electronic circuits that include electronic components for performing the functionality of one or more instructions, such as a field programmable gate array (FPGA), application specific integrated circuit (ASIC), or other electronic circuits. Instructions 206-212 can allow for providing a user interface for surfacing action items. Although instructions 206-212 are shown, it can be understood that the instructions can be performed in any order, without some of the instructions shown, and/or with the inclusion of other instructions not shown, and the instructions would still fall within the scope of the disclosure.

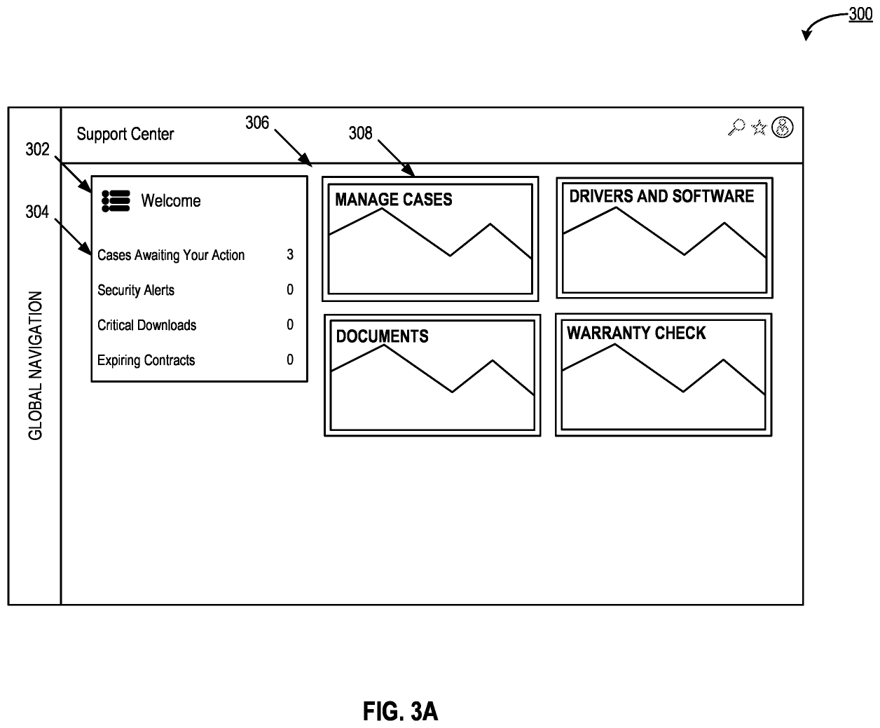

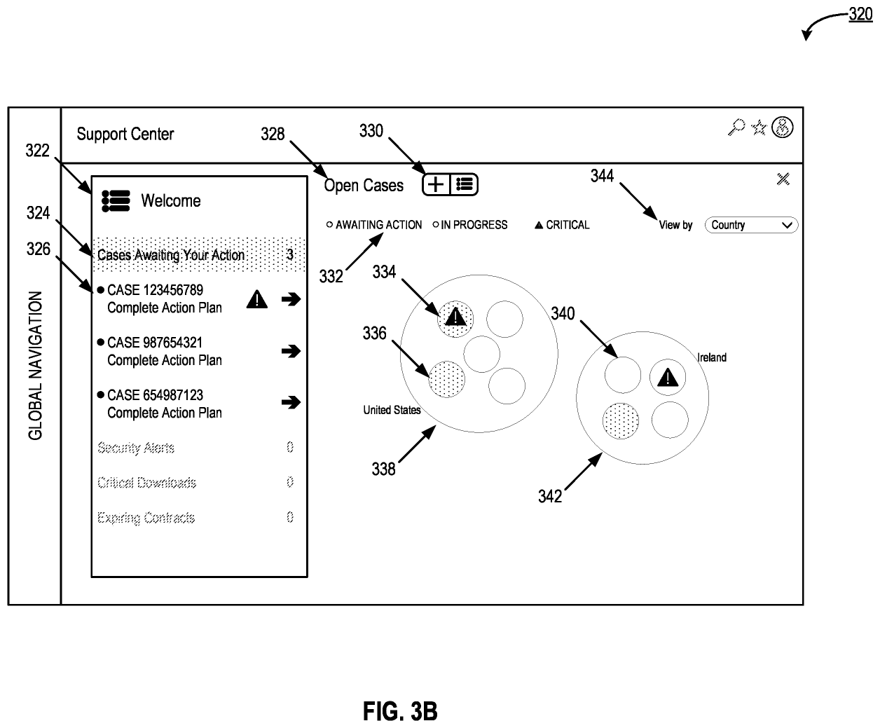

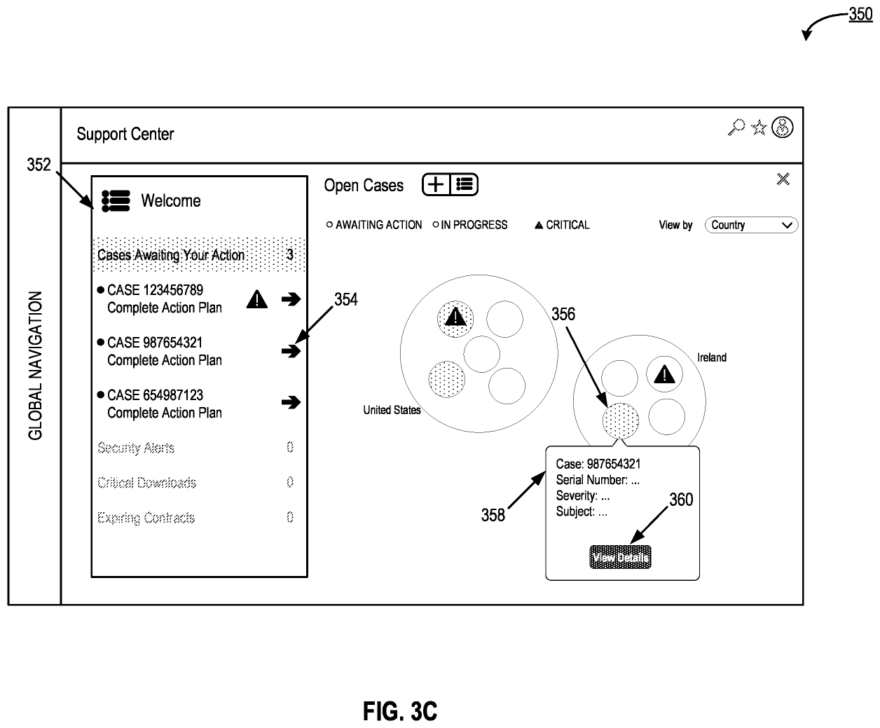

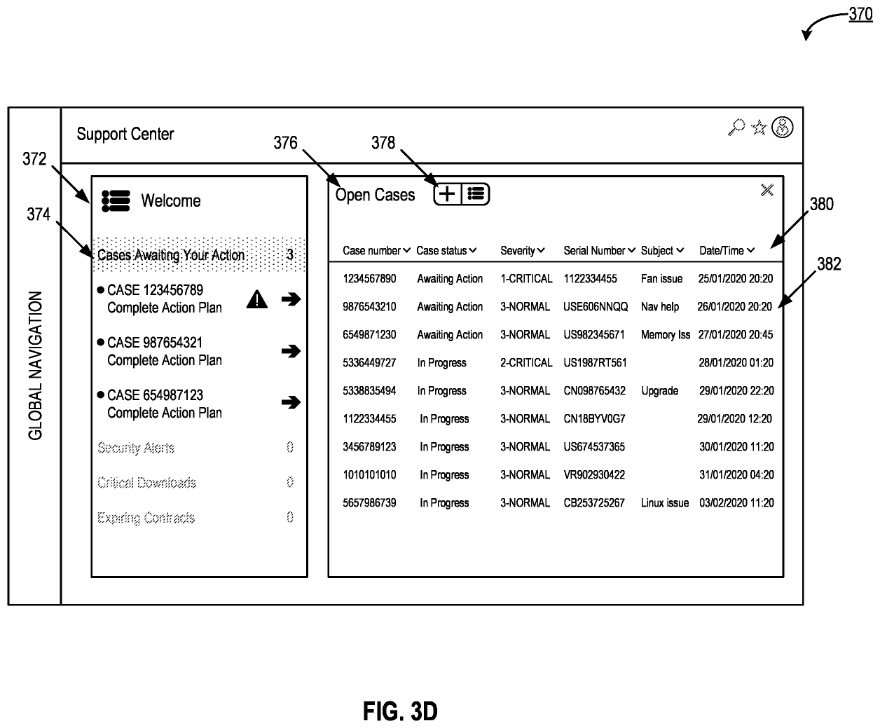

A machine-readable storage medium, such as machine-readable storage medium 204, may be any electronic, magnetic, optical, or other physical storage device that contains or stores executable instructions. Thus, machine-readable storage medium 204 may be, for example, Random Access Memory (RAM), non-volatile RAM (NVRAM), an Electrically Erasable Programmable Read-Only Memory (EEPROM), a storage device, an optical disc, and the like. In some aspects, machine-readable storage medium 204 may be a non-transitory storage medium, where the term “non-transitory” does not encompass transitory propagating signals. As described in detail below, machine-readable storage medium 204 may be encoded with executable instructions, for example, instructions 206-212, for providing a user interface for surfacing action items. Instructions 206-212 will be described with reference to aspects of FIGS. 3A-3D, described further herein below, as examples of the disclosed features.

Hardware processor 200 may execute instruction 206 to cause display, in an action panel, of a set of action items for a user. The action panel can be a user interface for surfacing action items to be performed by a user. In various aspects, the action panel can display action items in a circle scheme (e.g., bubble diagram). In the circle scheme, each action item is represented as a circle (e.g., bubble). The bubble can be colored based on characteristics associated with the action item. For example, the bubble can be colored based on whether the associated action item is critical, awaiting action, or in progress. Further, each circle can include an icon based on the characteristics associated with the action item. For example, the circle can include an exclamation point icon to indicate that the associated action item is critical. In the circle scheme, the circles can be organized within larger circles based on the characteristics associated with the respective action items represented by the circles. For example, the circles can be organized within larger circles associated with different geographical locations, countries, primary contacts, severity, service levels, statuses, or account names. For example, FIG. 3A illustrates an example where action items are organized within larger circles associated with different countries. Organizing each circle associated with action item within larger circles associated with different characteristics may be useful for prioritizing workflows and for providing an easily understandable visual of priorities, trends, and patterns. For example, organizing action item circles by severity level may help to prioritize more critical actions. As another example, organizing action item circles by primary contact may provide insight for managers (e.g., of support teams) regarding open case load per team member. As another example, organizing action item circles by account names may help to identify accounts associated with more service requests than other accounts.

A user can select a filter through an option in the action panel, and the action items in the action panel can be organized according to the selected filter. In various aspects, the action panel provides for filtering the circles based on characteristics associated with the action items represented by the circles. Filtering the circles can involve organizing the circles within larger circles representative of values associated with a characteristic. For example, filtering the circles based on geographical location can involve organizing the circles within larger circles based on countries associated with the action items represented by the circles. Each of the larger circles can represent a country. The circles within one of the larger circles can represent action items associated with the country represented by the larger circle. For example, FIG. 3A illustrates two larger circles where action items within one of the larger circles represent action items associated with the United States and action items within the other larger circles represent action items associated with Ireland. In various aspects, the action panel can use a combination of colors, icons, and larger circles to indicate various characteristics. For example, an action panel for a user can display circles with a first color (e.g., orange) for action items awaiting action, and circles with a second color (e.g., grey) for action items in progress. The action panel can display an exclamation point icon in circles for action items that are critical. The user can select a filter through an option in the action panel to organize the circles based on their characteristics and the selected filter. For example, the user can select countries, and the circles can be displayed in larger circles corresponding to different countries. For example, a first set of the circles can be displayed in a larger circle for a first country (e.g., United States of America), and a second set of the circles can be displayed in a larger circle for a second country (e.g., Canada). The user can select a different filter, and the circles can be reorganized or updated based on their characteristics and the selected filter. For example, the user can change the filter to account name. The circles can be reorganized so that a first set of the circles can be displayed in a larger circle for a first account name (e.g., a first customer), a second set of the circles can be displayed in a larger circle for a second account name (e.g., a second customer), and a third set of the circles can be displayed in a larger circle for a third account name (e.g., a third customer).

In various aspects, the action panel can display action items in a table scheme. In a table scheme, the action panel can display action items as entries in a table. An entry in the table can correspond to a row in the table. Characteristics associated with an action item can be provided on the same row as the associated entry in the table and separated by columns in the table. For example, FIG. 3D illustrates an example table scheme.

For example, an action panel for a user can display action items as entries in a table. A first action item in the table can correspond with a first entry in a first row in the table. In the first row, characteristics of the first action item, such as case number, case status, serial number, subject, date and time case was opened, geographical location, severity, and status associated with the first action item, are displayed in the first row in the table, in separate columns. A second action item in the table can correspond with a second entry in a second row in the table. In the second row, characteristics of the section action item, which in this example, is the geographical location, severity, and status of the second action item, are displayed in the second row in the table, in separate columns. As demonstrated in this example, the table scheme may provide for displaying different information (e.g., more information) on a user interface than a circle scheme.

The user can select a filter for the characteristics of the action items, for example, by selecting a column corresponding to one of the characteristics. The action items in the table can be sorted based on the characteristics of the respective action items and the selected filter for the characteristics. For example, FIG. 3D illustrates a top row 380 of characteristics, and selecting a column corresponding to one of the characteristics allows the table to be sorted by the selected characteristic. In various aspects, the action panel allows a user to switch between a circle scheme or a table scheme for displaying action items. Users may find switching schemes to be helpful in navigating action items.

In various aspects, the action panel can include a sidebar. The sidebar can include a list of action items that require attention from a user. For example, the list of action items can include action items associated with a critical status or an awaiting action status. In this way, the sidebar can act as a “to do” list for the user so that the action items that require attention are readily available while the user navigates through other action items in the action panel. For example, the action panel can display a sidebar that includes a list of critical status action items and display action items, which may include the critical status action items, in a circle scheme together in a user interface. A user can select various filters to organize the action items in the circle scheme while the sidebar maintains the list of critical status action items. Further, the user can switch between the circle scheme and a table scheme while the sidebar is maintained in the user interface. For example, FIG. 3A-3D illustrate respective sidebars 302, 322, 352, and 372 that may be maintained as the user navigates between the example interfaces illustrated therein. Various elements of the action panel described can be presented alternatively or in parallel in a user interface. Many variations are possible.

Hardware processor 200 may execute instruction 208 to determine a selection of an action item in the set of action items. A selection of an action item can be determined based on various interactions with an entry, circle, list, or other element representing an action item. For example, a user can interact with an element representing an action item with a mouse click, a mouse hover, a keyboard input, a touch gesture, or other input. As described herein, an action item may be displayed in multiple spaces of an action panel, such as in a sidebar, in a circle scheme, or in a table scheme of the action panel. In various aspects, a response to a selection of an action item may vary depending on where the action item was displayed when the selection of the action item was determined. For example, a selection of an action item in a table scheme may lead to a page for performing an action item while a selection of an action item in a sidebar or in a circle scheme may lead to a display of an overlay with additional information related to the action item. In various aspects, a response to a selection of an action item displayed in multiple spaces of an action panel may provide for the same response.

Hardware processor 200 may execute instruction 210 to cause display, in the action panel, of a window associated with the action item in response to the selection of the action item. In various aspects, the window can be displayed as a pop up window, or other user interface element, that overlays the action panel. The pop up window can include additional information associated with the action item that was selected. For example, the pop up window can include a case number, a serial number, and other characteristics (e.g., geographical locations, countries, primary contacts, severity, service levels, statuses, account names) associated with the action item. In various aspects, the window associated with the action item can include a button, or other interactive element, for a task (e.g., one of the tasks described with respect to FIG. 1) that corresponds with the action item. For example, the window can include a button to confirm an issue is resolved, confirm an action plan was implemented, or approve case closure. The button can act as a link to a page where the task that corresponds with the action item can be performed. In some cases, selection of an action item can lead to a display of a page associated with the action item. For example, in a table scheme, additional information associated with an action item may be displayed. Instead of displaying the additional information associated with the action item in a pop up window, a page associated with the action item can be displayed in response to a selection of the action item in the table scheme. The page may be associated with the action item can be for performing a task corresponding to the action item. In some cases, selection of an action item in a table scheme can lead to a display of a pop up window that includes additional information that is not displayed in the table scheme. In these cases, the pop up window can include a button, link, or other interactive element to the page associated with the action item where a task corresponding to the action item can be performed.

Hardware processor 200 may execute instruction 212 to cause a task (e.g., one of the tasks described with respect to FIG. 1) associated with the action item to be performed based on an interaction with the window. The task may be performed via a page associated with the action item. The page can be provided in response to an interaction with a button, a link, or other interactive element displayed in a window. The window can be provided in response to a selection of the action item. The page can provide functions for performing the task associated with the action item. For example, the page can provide functions such as uploading files, entering comments, and creating messages. In some cases, the task to be performed may not be performed through the page, and performance of the task is, instead, confirmed through the page. The page can provide for a detailed view of information associated with the action item. For example, the page can include a case history, past messages, past emails, and past comments associated with the action item. Upon performance or confirmation of performance of the task corresponding to the action item, the action item may be closed. Closing the action item allows a next action item in a task flow to be performed. The next action item in the task flow can be automatically surfaced, for example, by providing the action item as a circle or an entry in a user interface as described herein. In this way, the action items for which a user is responsible is readily accessible in the user interface.

FIG. 2B illustrates an example method 230 for surfacing action items in accordance with various aspects. The example method 230 can be associated with one or more functionalities performed by, for example, the example computing component 200 of FIG. 2A. In step 232, the example method 230 can cause display, in an action panel, of a set of action items for a user. In step 234, the example method 230 can determine a selection of an action item of the set of action items. In step 236, the example method 230 can cause display, in the action panel, of a window associated with the action item in response to the selection of the action item. In step 238, the example method 230 can cause a task associated with the action item to be performed based on an interaction with the window. There can be additional, fewer, or alternative steps performed in similar or alternative orders, or in parallel, based on the various features and aspects discussed herein unless otherwise stated.

FIG. 2C illustrates an example method 260 for surfacing action items in accordance with various aspects. The example method 260 can be associated with one or more functionalities performed by, for example, the example computing component 200 of FIG. 2A. In step 262, the example method 260 can cause display, in an action panel, of a set of action items for a user, wherein a set of circles are representative of the set of action items, wherein a first subset of the set of circles representative of a first subset of the set of action items are displayed in a first large circle representative of a first value of a first characteristic associated with the set of action items, and wherein a second subset of the set of circles representative of a second subset of the set of circles representative of a second subset of the set of action items are displayed in a second large circle representative of a second value of the first characteristic associated with the set of action items. In step 264, the example method 260 can determine a selection of an action item of the set of action items. In step 266, the example method 260 can cause display, in the action panel, of a window associated with the action item in response to the selection of the action item. In step 268, the example method 260 can cause a task associated with the action item to be performed based on an interaction with the window. There can be additional, fewer, or alternative steps performed in similar or alternative orders, or in parallel, based on the various features and aspects discussed herein unless otherwise stated.

FIGS. 3A-3D illustrate example user interfaces (e.g., action panels) associated with surfacing action items in accordance with various aspects. The example user interfaces can be associated with one or more functionalities performed by, for example, the example computing component 200 of FIG. 2A. It should be understood that there can be additional, fewer, or alternative steps performed in similar or alternative orders, or in parallel, based on the various features and aspects discussed herein unless otherwise stated.

FIG. 3A illustrates an example user interface 300 in accordance with various aspects. The example user interface 300 can be associated with a workspace home or a starting point for performing action items in a task flow (e.g., the task flow described with respect to FIG. 1). The example user interface 300 displays a sidebar 302 that includes categories of action items 304 that require attention from a user. As illustrated in this example, the categories of action items 304 include “Cases Awaiting Your Action,” “Security Alerts,” “Critical Downloads,” and “Expiring Contracts.” The sidebar 302 includes a count of the action items that require attention from the user (e.g., “Cases Awaiting Your Action” has 3 action items). Different categories of action items may be possible for different task flows or different applications. The example user interface 300 displays a menu 306 that links to various pages. In this example, the “Manage Cases” link 308 provides access to an action panel for surfacing action items.

FIG. 3B illustrates an example user interface 320 in accordance with various aspects. The example user interface 320 can be displayed, for example, in response to an interaction with a link such as the “Manage Cases” link 308 of FIG. 3A. As illustrated in this example, the example user interface 320 includes a sidebar 322. The sidebar 322 includes categories of action items that require attention from a user. In this example, the “Cases Awaiting Your Action” category of action items 324 has been highlighted and three action items that fall within this category of action items are displayed in the example user interface 320. The three action items in this example include a critical case 326 associated with a critical action item. The critical case 326 is displayed with an exclamation icon to indicate a critical status for the critical action item associated with the critical case 326.

As illustrated in this example, the example user interface 320 includes an open cases section 328. The open cases section 328 can use a circle scheme to display various action items as circles. The open cases section 328 may include a button 330. The button 330 allows a user to switch between the circle scheme and a table scheme in the example user interface 320. The open cases section 328 may include a legend 332. The legend 332 can indicate colors associated with statuses of action items. As illustrated in this example, the open cases section uses a circle scheme to display action items organized by countries. A first larger circle 338 contains action items associated with a first country (e.g., “United States”). A second larger circle 342 contains action items associated with a second country (e.g., “Ireland”). The action items can be filtered by different characteristics based on a selection of a filter 344. The first larger circle 338 contains a first circle 334 for an action item that is critical and awaiting action, as indicated by a color and icon of the first circle 334. The first larger circle 338 contains a second circle 336 for an action item that is awaiting action, as indicated by a color of the second circle 336. The second larger circle 342 contains a third circle 340 for an action item that is in progress, as indicated by a color of the third circle 340. As illustrated in this example, an action panel, such as the example user interface 320, for surfacing action items can efficiently display critical action items in need of attention.

FIG. 3C illustrates an example user interface 350 in accordance with various aspects. The example user interface 350 can be displayed, for example, in response to an interaction with an action item listed in the sidebar 322 of FIG. 3B or a circle for the action in FIG. 3B. As illustrated in this example, the example user interface 350 includes a pop up window 358 with additional information associated with an action item for circle 356. The action item for circle 356 can be associated with a case 354 displayed in the sidebar 352 of the example user interface 350. The pop up window 358 may include a button 360 for performing a task (e.g., one of the tasks described with respect to FIG. 1) associated with the action item for circle 356 and case 354. As illustrated in this example, an action panel, such as the example user interface 350, can provide for multiple ways to perform a task associated with an action item.

FIG. 3D illustrates an example user interface 370 in accordance with various aspects. The example user interface 370 can be displayed, for example, in response to an interaction with a button 330 of FIG. 3B for switching between a circle scheme and a table scheme. As illustrated in this example, the example user interface 370 includes a sidebar 372 that includes categories of action items 374. The sidebar 372 in this example can be, for example, maintained from the sidebar 322 of FIG. 3B after the interaction with the button 330 of FIG. 3B. In this example, the open cases section 328 of FIG. 3B is replaced with the open cases section 376. The open cases section 376 may include a button 378 for switching between the table scheme and a circle scheme, such as the circle scheme illustrated in FIG. 3B. The open cases section 376 may include a table of entries 382 corresponding to action items. Each entry in the table of entries includes characteristics (e.g., “Case number,” “Case status,” “Severity,” “Serial Number,” “Subject,” “Date/Time”) associated with the corresponding action item. Each characteristic is identified in a top row 380 of the table of entries 382. The table of entries 382 can be filtered by each characteristic by interacting with the characteristic in the top row 380. As illustrated in this example, switching between a circle scheme and a table scheme allows a user to view action items in different contexts.

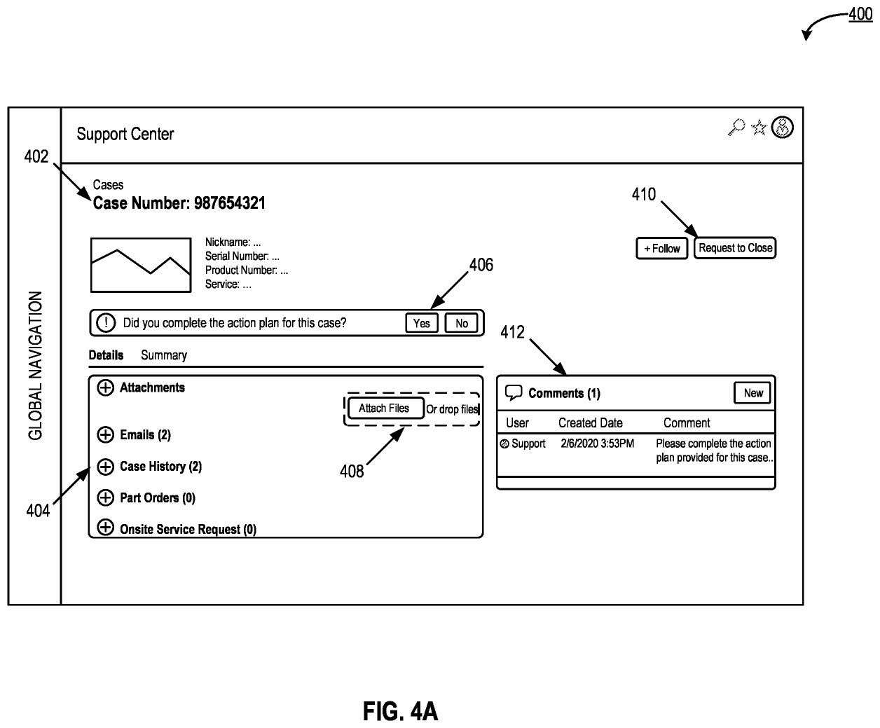

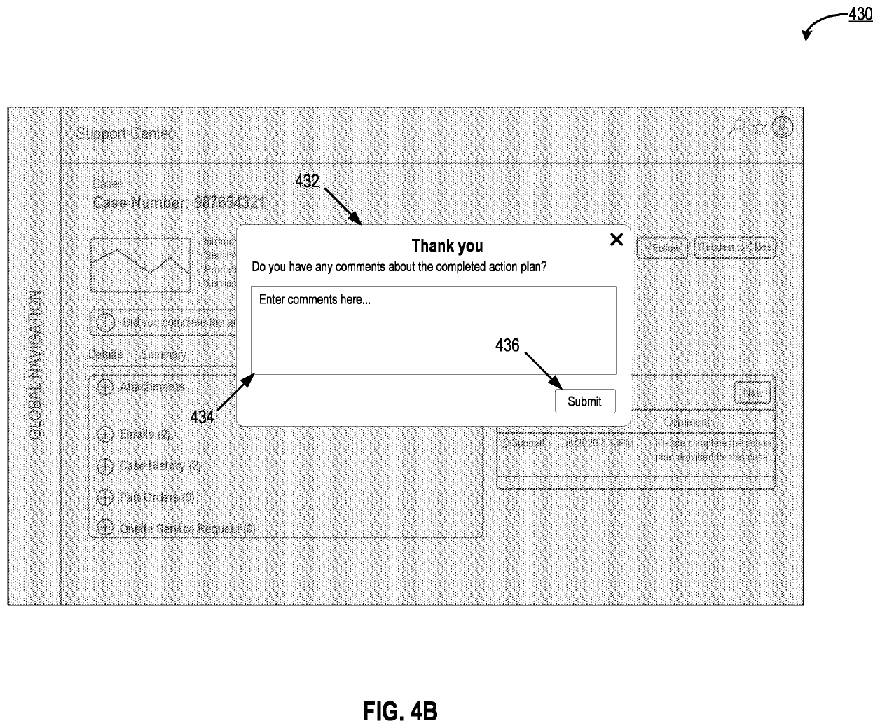

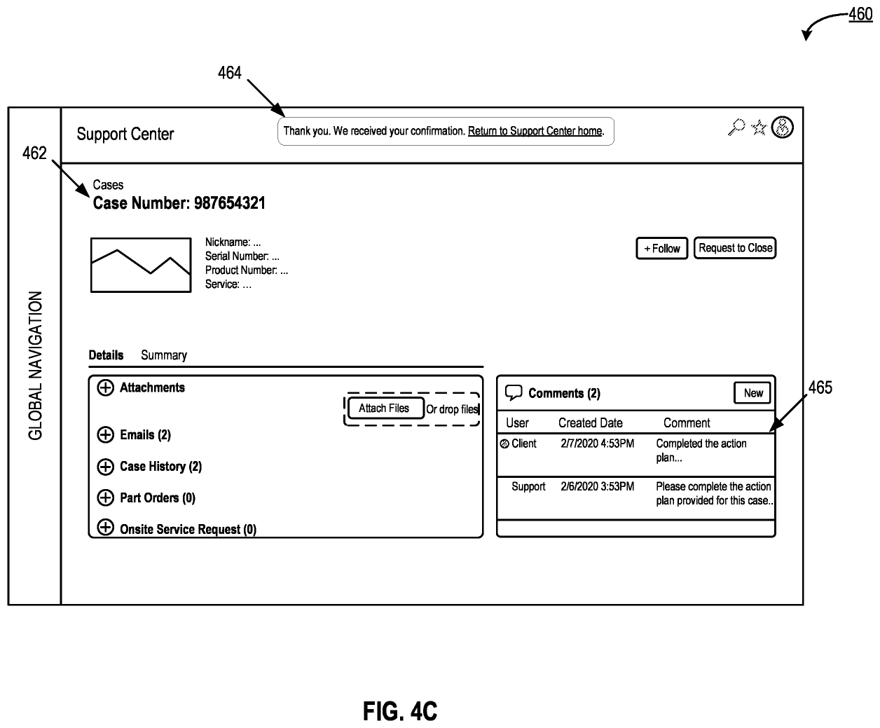

FIGS. 4A-4C illustrate example user interfaces (e.g., pages) associated with interacting with an action item in accordance with various aspects. The example user interfaces can be associated with one or more functionalities performed by, for example, the example computing component 200 of FIG. 2A. It should be understood that there can be additional, fewer, or alternative steps performed in similar or alternative orders, or in parallel, based on the various features and aspects discussed herein unless otherwise stated.

FIG. 4A illustrates an example user interface 400 in accordance with various aspects. The example user interface 400 can be associated with performing a task (e.g., one of the tasks described with respect to FIG. 1) associated with an action item. The example user interface 400 can be displayed, for example, in response to an interaction with a button, link, or other interactive element provided in an action panel. For example, the example user interface 400 can be displayed in response to the button 360 of FIG. 3C. As illustrated in this example, the example user interface 400 includes a label 402 identifying the action item with which the task to be performed corresponds. In this example, the task may be to complete an action plan.

The example user interface 400 may include various functionalities associated with the action item and may be used as part of performance of the task to complete the action plan. The example user interface 400 may include a detailed view of information 404 associated with the action item. The detailed view of information 404 can include various information and, in this example, includes attachments, emails, case history, part orders, and onsite service requests. The example user interface 400 may include a button 408 for uploading attachments. For example, a user may use the button 408 to upload a log file associated with the action item. The example user interface 400 may include a confirmation 406 for confirming completion of a task corresponding with the action item. For example, a user may confirm that the action plan was completed using the confirmation 406. The example user interface 400 may include a comments section 412. The comments section 412 can include past comments associated with the action item. The example user interface 400 may include a button 410 to request to close the action item. For example, a user can use the button 410 to request to close the action item or remove the action item (e.g., because the task corresponding to the action item was completed or because the task corresponding to the action item cannot be completed). As illustrated in this example, providing the various information associated with an action item and various functions for performing a task associated with the action item allows the task to be efficiently performed.

FIG. 4B illustrates an example user interface 430 in accordance with various aspects. The example user interface 430 can be displayed, for example, in response to an interaction with the confirmation 406 of FIG. 4A confirming that a task (e.g., complete an action plan) associated with an action item was completed. In this example, the example user interface 430 includes a pop up window 432 that includes an input field 434 for a user to input comments associated with completion of the task. The pop up window 432 may include a submit button 436 for submitting comments that the user inputted. For example, a user may input comments related to completion of a task, such as feedback from a customer or additional information related to the task, in the input field 434. The user can interact with the submit button 436 to submit the comments inputted in the input field 434 and finalize completion of the task.

FIG. 4C illustrates an example user interface 460 in accordance with various aspects. The example user interface 460 can be displayed, for example, in response to an interaction with the submit button 436 of FIG. 4B, confirming completion of a task (e.g., complete an action plan) associated with an action item. As illustrated in this example, the example user interface 460 includes a label 462 identifying the case number of the action item with which the completed task corresponds. In this example, the example user interface 460 includes a confirmation message 464. The confirmation message confirms that a confirmation of a completion of a task was made by a user. As the confirmation that the task was completed can trigger a new action item to be performed, the confirmation message 464 may include a link to return to a home page or starting point for accessing action items. At this point, new action items to be performed by the user may be surfaced. In this way, the task flows associated with the user can progress smoothly and efficiently. As illustrated in this example, the example user interface 460 may include a label 465 displaying the user action and comments has been adhered to the case.

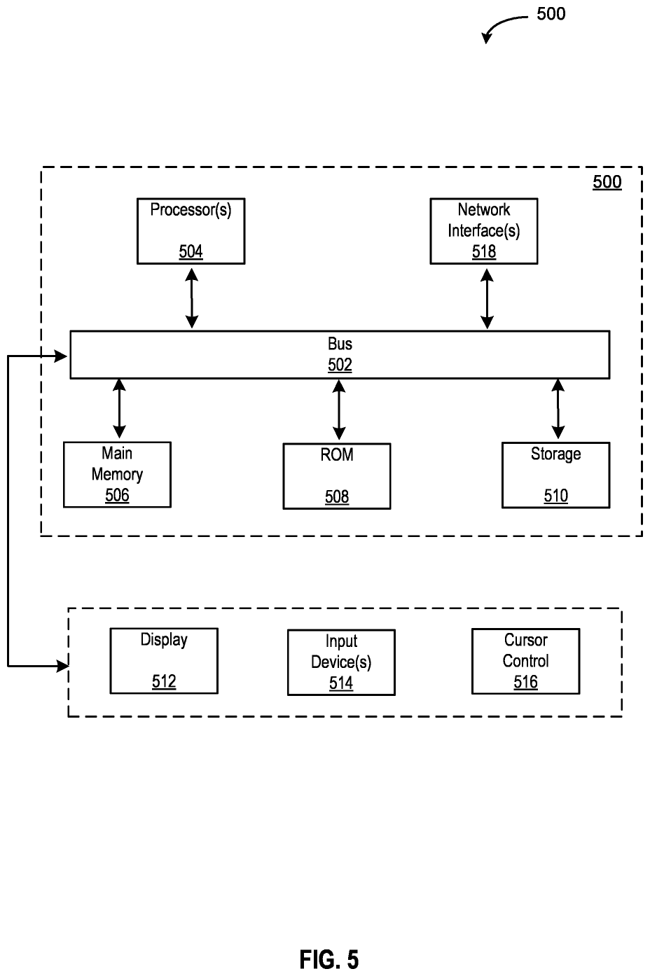

FIG. 5 depicts a block diagram of an example computer system 500 in which various of the aspects described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to a display 512, such as a liquid crystal display (LCD) (or touch screen), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. In some aspects, the same direction information and command selections as cursor control may be implemented via receiving touches on a touch screen without a cursor.

The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which in combination with the computer system causes or programs computer system 500 to be a special-purpose machine. According to one aspect, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative aspects, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

The computer system 500 also includes a communication interface 518 coupled to bus 502. Network interface 518 provides a two-way data communication coupling to one or more network links that are connected to one or more local networks. For example, communication interface 518 may be an integrated services digital network (ISDN) card, cable modem, satellite modem, or a modem to provide a data communication connection to a corresponding type of telephone line. As another example, network interface 518 may be a local area network (LAN) card to provide a data communication connection to a compatible LAN (or WAN component to communicated with a WAN). Wireless links may also be implemented. In any such implementation, network interface 518 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the worldwide packet data communication network now commonly referred to as the “Internet.” Local network and Internet both use electrical, electromagnetic or optical signals that carry digital data streams. The signals through the various networks and the signals on network link and through communication interface 518, which carry the digital data to and from computer system 500, are example forms of transmission media.

The computer system 500 can send messages and receive data, including program code, through the network(s), network link and communication interface 518. In the Internet example, a server might transmit a requested code for an application program through the Internet, the ISP, the local network and the communication interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example aspects. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 500.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain aspects include, while other aspects do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

1. A method comprising:
causing display, in an action panel, of a set of pending task flow-related action items for a user;
determining a selection of a pending task flow-related action item of the set of pending task flow-related action items;
causing display, in the action panel, of a window associated with the pending task flow-related action item in response to the selection of the pending task flow-related action item; and
progressing a task flow associated with the pending task flow-related action item based on a first interaction with the window, the task flow comprising a sequence of task flow-related action items that depend on performance of the pending task flow-related action item.

2. The method of claim 1, wherein a set of circles are representative of the set of pending task flow-related action items, wherein a first subset of the set of circles representative of a first subset of the set of pending task flow-related action items are displayed in a first large circle representative of a first value of a first characteristic associated with the set of pending task flow-related action items, and wherein a second subset of the set of circles representative of a second subset of the set of pending task flow-related action items are displayed in a second large circle representative of a second value of the first characteristic associated with the set of pending task flow-related action items.

3. The method of claim 2, further comprising:
determining a selection of a filter for a second characteristic associated with the set of pending task flow-related action items; and
reorganizing display of the set of pending task flow-related action items, wherein the first subset of the set of circles and the second subset of the set of circles are reorganized to a third subset of the set of circles representative of a third subset of the set of pending task flow-related action items displayed in a third large circle representative of a third value of the second characteristic, and wherein a fourth subset of the set of circles representative of a fourth subset of the set of pending task flow-related action items displayed in a fourth large circle representative of a fourth value of the second characteristic.

4. The method of claim 1, wherein a set of entries in a table are representative of the set of pending task flow-related action items, wherein the table includes columns representative of characteristics associated with the set of pending task flow-related action items, and wherein the set of entries are sortable based on the characteristics in response to a second interaction with the columns.

5. The method of claim 1, wherein the action panel includes a sidebar, and the sidebar includes a list of at least a subset of the set of pending task flow-related action items.

6. The method of claim 1, wherein the window associated with the action item includes a link to a page associated with the action item, wherein the first interaction with the window includes a click on the link, and wherein the progressing the task flow associated with the pending task flow-related action item is further based on a second interaction with the page.

7. The method of claim 6, wherein the page associated with the pending task flow-related action item includes one or more functions to perform the progressing of the task flow associated with the pending task flow-related action item, and wherein the one or more functions includes a function to close the pending task flow-related action item.

8. A system, comprising:
a processor; and
a memory operatively connected to the processor, and including computer code that when executed, causes the system to:
causing display, in an action panel, of a set of pending task flow-related action items for a user;
determining a selection of a pending task flow-related action item of the set of pending task flow-related action items;
causing display, in the action panel, of a window associated with the pending task flow-related action item in response to the selection of the pending task flow-related action item; and
progressing a task flow associated with the pending task flow-related action item based on a first interaction with the window, the task flow comprising a sequence of task flow-related action items that depend on performance of pending task flow-related action item.

9. The system of claim 8, wherein a set of circles are representative of the set of pending task flow-related action items, wherein a first subset of the set of circles representative of a first subset of the set of pending task flow-related action items are displayed in a first large circle representative of a first value of a first characteristic associated with the set of pending task flow-related action items, and wherein a second subset of the set of circles representative of a second subset of the set of pending task flow-related action items are displayed in a second large circle representative of a second value of the first characteristic associated with the set of pending task flow-related action items.

10. The system of claim 9, wherein the computer code further causes the system to:
determining a selection of a filter for a second characteristic associated with the set of pending task flow-related action items; and
reorganizing display of the set of pending task flow-related action items, wherein the first subset of the set of circles and the second subset of the set of circles are reorganized to a third subset of the set of circles representative of a third subset of set of pending task flow-related action items displayed in a third large circle representative of a third value of the second characteristic, and wherein a fourth subset of the set of circles representative of a fourth subset of the set of pending task flow-related action items displayed in a fourth large circle representative of a fourth value of the second characteristic.

11. The system of claim 8, wherein a set of entries in a table are representative of the set of pending task flow-related action items, wherein the table includes columns representative of characteristics associated with the set of pending task flow-related action items, and wherein the set of entries are sortable based on the characteristics in response to a second interaction with the columns.

12. The system of claim 8, wherein the action panel includes a sidebar, and the sidebar includes a list of at least a subset of the set of pending task flow-related action items.

13. The system of claim 8, wherein the window associated with the action item includes a link to a page associated with the action item, wherein the first interaction with the window includes a click on the link, and wherein the progressing the task flow associated with the pending task flow-related action item is further based on a second interaction with the page.

14. The system of claim 13, wherein the page associated with the action item includes one or more functions to perform the progressing of the task flow associated with the pending task flow-related action item, and wherein the one or more functions includes a function to close the pending task flow-related action item.

15. A non-transitory computer-readable storage medium including instructions that, when executed by at least one processor of a computing system, cause the computing system to:
causing display, in an action panel, of a set of pending task flow-related action items for a user;
determining a selection of a pending task flow-related action item of the set of pending task flow-related action items;
causing display, in the action panel, of a window associated with the pending task flow-related action item in response to the selection of the pending task flow-related action item; and
progressing a task flow associated with the pending task flow-related action item based on a first interaction with the window, the task flow comprising a sequence of task flow-related action items that depend on performance of the pending task flow-related action item.

16. The non-transitory computer-readable storage medium of claim 15, wherein a set of circles are representative of the set of pending task flow-related action items, wherein a first subset of the set of circles representative of a first subset of the set of action items are displayed in a first large circle representative of a first value of a first characteristic associated with the set of pending task flow-related action items, and wherein a second subset of the set of circles representative of a second subset of the set of pending task flow-related action items are displayed in a second large circle representative of a second value of the first characteristic associated with the set of pending task flow-related action items.

17. The non-transitory computer-readable storage medium of claim 16, wherein the instructions further cause the computing system to:
determining a selection of a filter for a second characteristic associated with the set of pending task flow-related action items; and
reorganizing display of the set of pending task flow-related action items, wherein the first subset of the set of circles and the second subset of the set of circles are reorganized to a third subset of the set of circles representative of a third subset of the set of pending task flow-related action items displayed in a third large circle representative of a third value of the second characteristic, and wherein a fourth subset of the set of circles representative of a fourth subset of the set of action items displayed in a fourth large circle representative of a fourth value of the second characteristic.

18. The non-transitory computer-readable storage medium of claim 15, wherein a set of entries in a table are representative of the set of pending task flow-related action items, wherein the table includes columns representative of characteristics associated with the set of pending task flow-related action items, and wherein the set of entries are sortable based on the characteristics in response to a second interaction with the columns.

19. The non-transitory computer-readable storage medium of claim 15, wherein the action panel includes a sidebar, and the sidebar includes a list of at least a subset of the set of pending task flow-related action items.

20. The non-transitory computer-readable storage medium of claim 15, wherein the window associated with the action item includes a link to a page associated with the action item, wherein the first interaction with the window includes a click on the link, and wherein the progressing the task flow associated with the pending task flow-related action item is further based on a second interaction with the page.
